(19) United States
(12) Patent Application Publication
(10) Pub. No.: US 2014/0252120 A1
(43) Pub. Date: Sep. 11, 2014

(54) LOW PROFILE SYNTHETIC JET ACTUATOR EQUIPPED WITH MOVING ARMATURES AND STACKABLE PLATES

(71) Applicant: NUVENTIX, INC., Austin, TX (US)

(72) Inventors: Timothy S. Lucas, Richmond, VA (US); Stephen P. Darbin, Austin, TX (US); Raghavendran Mahalingam, Austin, TX (US); Andrew Poynot, Austin, TX (US); Daniel N. Grimm, Round Rock, TX (US); Randall P. Williams, Austin, TX (US)

(73) Assignee: NUVENTIX, INC., Austin, TX (US)

(21) Appl. No.: 14/203,549

(22) Filed: Mar. 10, 2014

Related U.S. Application Data
(60) Provisional application No. 61/857,737, filed on Jul. 24, 2013.
(60) Provisional application No. 61/776,011, filed on Mar. 11, 2013.
(60) Provisional application No. 61/776,028, filed on Mar. 11, 2013.
(60) Provisional application No. 61/776,066, filed on Mar. 11, 2013.
(60) Provisional application No. 61/801,399, filed on Mar. 15, 2013.
(60) Provisional application No. 61/838,670, filed on Jun. 24, 2013.
(60) Provisional application No. 61/777,185, filed on Mar. 12, 2013.
(60) Provisional application No. 61/837,526, filed on Jun. 20, 2013.
(60) Provisional application No. 61/829,318, filed on May 31, 2013.
(60) Provisional application No. 61/828,894, filed on May 30, 2013.

(51) Int. Cl. B05B 17/06

(52) U.S. Cl. CPC B05B 17/0615
USPC 239/102.2

(57) ABSTRACT

A synthetic jet ejector (201) is provided which includes a housing assembly (239, 241) which is equipped with a first plurality of openings (203, 207) and a second plurality of openings (205, 209), and a diaphragm assembly disposed within the housing assembly. The diaphragm assembly includes first (229) and second (243) armatures, a coil (235) disposed between the first and second armatures, first (221) and second (255) end caps, a first diaphragm (223) disposed between the first end cap and the first armature, and a second diaphragm (249) disposed between the second end cap and the second armature. The first and second diaphragms contain a first set of keying features (273) which keys them to the housing assembly. The synthetic jet ejector emits a first plurality of synthetic jets out of the first plurality of openings, and emits a second plurality of synthetic jets out of the second plurality of openings.

### CROSS-REFERENCE TO RELATED APPLICATIONS

This application claims the benefit of U.S. Provisional Application No. 61/857,737, filed Jul. 24, 2013, having the same title, and which is incorporated herein by reference in its entirety; and also claims the benefit of U.S. Provisional Application Number 61/776,011, filed Mar. 11, 2013, entitled “LOW PROFILE SYNTHETIC JET ACTUATOR”, and which is incorporated herein by reference in its entirety; and also claims the benefit of U.S. Provisional Application No. 61/776,028, filed Mar. 11, 2013, entitled “METHOD OF ESTIMATING THE STROKE OF VARIABLE-RELUCTANCE SYNTHETIC JET ACTUATORS USING COIL IMPEDANCE”, and which is incorporated herein by reference in its entirety; and also claims the benefit of U.S. Provisional Application No. 61/776,066, filed Mar. 11, 2013, entitled “NOZZLE CONFIGURATION FOR SYNTHETIC JET ACTUATOR FOR RE-INGESTION REDUCTION”, and which is incorporated herein by reference in its entirety; and also claims the benefit of U.S. Provisional Application No. 61/801,399, filed Mar. 15, 2013, entitled “SYSTEMS AND METHODOLOGIES FOR MITIGATING ACOUSTIC EMISSIONS IN SYNTHETIC JET EJECTORS”; and also claims the benefit of U.S. Provisional Application Number 61/838,670, filed Jun. 24, 2013, entitled “METHOD FOR ESTIMATING THE STROKE OF A VARIABLE RESISTANCE SYNTHETIC JET ACTUATOR”, and which is incorporated herein by reference in its entirety; and also claims the benefit of U.S. Provisional No. 61/777,185, filed Mar. 12, 2013, entitled “FLAT SPRING CONFIGURATIONS FOR SYNTHETIC JET ACTUATOR”, and which is incorporated herein by reference in its entirety; and also claims the benefit of U.S. Provisional Application No. 61/837,526, filed Jun. 20, 2013, entitled “DIAPHRAGMS FOR SYNTHETIC JET ACTUATORS AND METHODS FOR MANUFACTURING THE SAME”, and which is incorporated herein by reference in its entirety; and also claims the benefit of U.S. Provisional Application No. 61/829,318, filed May 31, 2013, entitled “MOVING ARMATURE SYNTHETIC JET ACTUATOR DESIGN WITH STACKABLE PLATES”, and which is incorporated herein by reference in its entirety.

### FIELD OF THE DISCLOSURE

The present disclosure relates generally to synthetic jet ejectors, and more particularly to synthetic jet ejectors having a moving armature design.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile thermal management solution, especially in applications where thermal management is required at the local level.

Various examples of synthetic jet ejectors are known to the art. Earlier examples are described in U.S. Pat. No. 5,758,823 (Glezer et al.), entitled “Synthetic Jet Actuator and Applications Thereof'; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows”; U.S. Pat. No. 6,056,204 (Glezer et al.), entitled “Synthetic Jet Actuators for Mixing Applications”; U.S. Pat. No. 6,123,145 (Glezer et al.), entitled “Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques”.

Further advances have been made in the art of synthetic jet ejectors, both with respect to synthetic jet ejector technology in general and with respect to the applications of this technology. Some examples of these advances are described in U.S. 20100263838 (Mahalingam et al.), entitled “Synthetic Jet Ejector for Augmentation of Pumped Liquid Loop Cooling and Enhancement of Pool and Flow Boiling”; U.S. 20100039012 (Grimm), entitled “Advanced Synjet Cooler Design For LED Light Modules”; U.S. 20100033071 (Heffington et al.), entitled “Thermal management of LED Illumination Devices”; U.S. 20090141065 (Darbin et al.), entitled “Method and Apparatus for Controlling Diaphragm Displacement in Synthetic Jet Actuators”; U.S. 20090109625 (Booth et al.), entitled Light Fixture with Multiple LEDs and Synthetic Jet Thermal Management System“; U.S. 20090084866 (Grimm et al.), entitled Vibration Balanced Synthetic Jet Ejector”; U.S. 20080295997 (Heffington et al.), entitled “Synthetic Jet Ejector with Viewing Window and Temporal Aliasing”; U.S. 20080219007 (Heffington et al.), entitled “Thermal Management System for LED Array”; U.S. 20080151541 (Heffington et al.), entitled “Thermal Management System for LED Array”; U.S. 20080043061 (Glezer et al.), entitled “Methods for Reducing the Non-Linear Behavior of Actuators Used for Synthetic Jets”; U.S. 20080009187 (Grimm et al.), entitled “Moldable Housing design for Synthetic Jet Ejector”; U.S. 20080006393 (Grimm), entitled “Vibration Isolation System for Synthetic Jet Devices”; U.S. 20070272393 (Reichenbach), entitled “Electronics Package for Synthetic Jet Ejectors”; U.S. 20070141453 (Mahalingam et al.), entitled “Thermal Management of Batteries using Synthetic Jets”; U.S. 20070096118 (Mahalingam et al.), entitled “Synthetic Jet Cooling System for LED Module”; U.S. 20070081027 (Beltran et al.), entitled “Acoustic Resonator for Synthetic Jet Generation for Thermal Management”; U.S. 20070023169 (Mahalingam et al.), entitled “Synthetic Jet Ejector for Augmentation of Pumped Liquid Loop Cooling and Enhancement of Pool and Flow Boiling”; U.S. 20070119573 (Mahalingam et al.), entitled “Synthetic Jet Ejector for the Thermal Management of PCI Cards”; U.S. 20070119575 (Glezer et al.), entitled “Synthetic Jet Heat Pipe Thermal Management System”; U.S. 20070127210 (Mahalingam et al.), entitled “Thermal Management System for Distributed Heat Sources”; U.S. 20070141453 (Mahalingam et al.), entitled “Thermal Management of Batteries using Synthetic Jets”; U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; U.S. Pat. No. 7,607,470 (Glezer et al.), entitled “Synthetic Jet Heat Pipe Thermal Management System”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. Pat. No. 7,784,972 (Heffington et al.), entitled “Thermal Management System for LED Array”; and U.S. Pat. No. 7,819,556 (Heffington et al.), entitled “Thermal Management System for LED Array”.

Some energy transfer devices have also been developed in the art which may be utilized to transfer energy to a fluid. One example of such a device is disclosed in U.S. 2013/0039787 (Lucas), which is incorporated herein by reference in its entirety. The device depicted therein includes a diaphragm and a diaphragm substrate including cutouts. The cutouts are covered with a sealing layer bonded to the diaphragm substrate. The cutouts are configured to bend, thereby allowing displacement of a center portion of the diaphragm. The displacement of the center portion of the diaphragm transfers energy to a fluid located adjacent to the diaphragm.

### BRIEF DESCRIPTION OF THE DRAWINGS

FIGS. 1A-1C are illustrations depicting the manner in which a synthetic jet actuator operates.

FIG. 2 is a perspective view of a particular, non-limiting embodiment of a synthetic jet ejector with moving armatures in accordance with the teachings herein (the opposing view is a mirror image of FIG. 2).

FIG. 3 is another perspective view of the synthetic jet ejector of FIG. 2.

FIGS. 4-6 are, collectively, an exploded view of the synthetic jet ejector of FIG. 2.

FIG. 7 is a cross-sectional view taken along LINE 7-7 of FIG. 2.

FIG. 8 is a cross-sectional view taken along LINE 8-8 of FIG. 2.

FIGS. 9-12 are perspective views of the synthetic jet ejector of FIG. 2 shown in successive states of disassembly.

FIG. 13 is an illustration of a diaphragm utilized in the synthetic jet ejector of FIG. 2.

FIGS. 14-16 are perspective views showing the details of the chassis elements of the synthetic jet ejector of FIG. 2.

### SUMMARY OF THE DISCLOSURE

In one aspect, a synthetic jet ejector is provided which comprises a housing assembly which is equipped with a first plurality of openings and a second plurality of openings; and a diaphragm assembly disposed within said housing assembly, wherein said diaphragm assembly includes (a) first and second armatures, (b) a coil disposed between said first and second armatures, (c) first and second end caps, (d) a first diaphragm disposed between said first end cap and said first armature, and (e) a second diaphragm disposed between said second end cap and said second armature; wherein said first and second diaphragms contain a first set of keying features which keys them to the housing assembly, wherein said synthetic jet ejector emits a first plurality of synthetic jets out of said first plurality of openings, and wherein said synthetic jet ejector emits a second plurality of synthetic jets out of said second plurality of openings.

### DETAILED DESCRIPTION

The systems, devices and methodologies disclosed herein utilize synthetic jet actuators or synthetic jet ejectors. Prior to describing these systems, devices and methodologies, a brief explanation of a typical synthetic jet ejector, and the manner in which it operates to create a synthetic jet, may be useful.

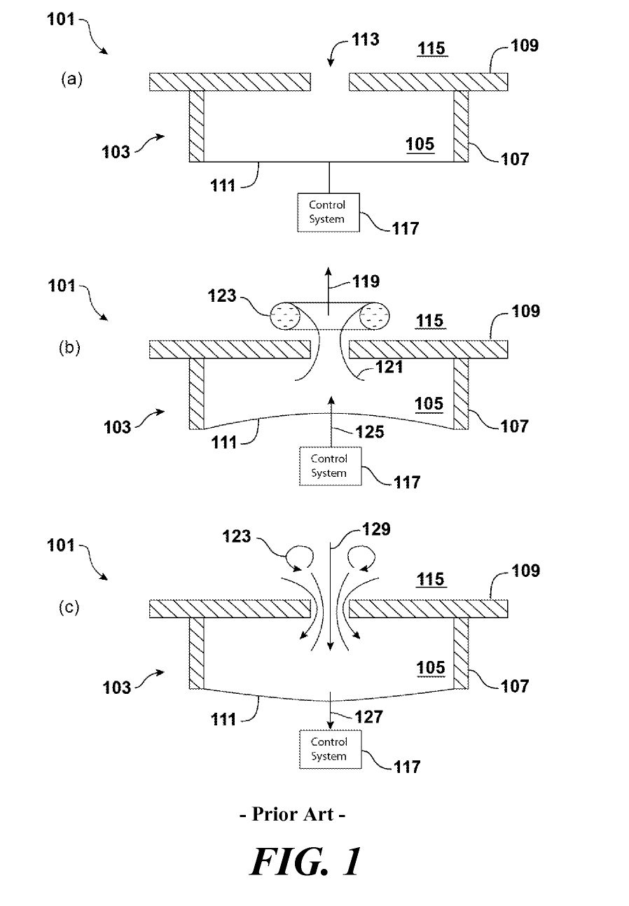

FIG. 1 illustrates the operation of a typical synthetic jet ejector in forming a synthetic jet. As seen therein, the synthetic jet ejector 101 comprises a housing 103 which defines and encloses an internal chamber 105. The housing 103 and chamber 105 may take virtually any geometric configuration, but for purposes of discussion and understanding, the housing 103 is shown in cross-section in FIG. 1 to have a rigid side wall 107, a rigid front wall 109, and a rear diaphragm 111 that is flexible to an extent to permit movement of the diaphragm 111 inwardly and outwardly relative to the chamber 105. The front wall 109 has an orifice 113 therein which may be of various geometric shapes. The orifice 113 diametrically opposes the rear diaphragm 111 and fluidically connects the internal chamber 105 to an external environment having ambient fluid 115.

The movement of the flexible diaphragm 111 may be achieved with a voice coil or other suitable actuator, and may be controlled by a suitable control system 117. The diaphragm 111 may also be equipped with a metal layer, and a metal electrode may be disposed adjacent to, but spaced apart from, the metal layer so that the diaphragm 111 can be moved via an electrical bias imposed between the electrode and the metal layer. Moreover, the generation of the electrical bias can be controlled by any suitable device including, but not limited to, a computer, logic processor, or signal generator. The control system 117 can cause the diaphragm 111 to move periodically or to modulate in time-harmonic motion, thus forcing fluid in and out of the orifice 113.

Alternatively, a piezoelectric actuator could be attached to the diaphragm 111. The control system would, in that case, cause the piezoelectric actuator to vibrate and thereby move the diaphragm 111 in time-harmonic motion. The method of causing the diaphragm 111 to modulate is not particularly limited to any particular means or structure.

The operation of the synthetic jet ejector 101 will now be described with reference to FIGS. 1b-1c. FIG. 1b depicts the synthetic jet ejector 101 as the diaphragm 111 is controlled to move inward into the chamber 105, as depicted by arrow 125. The inward motion of the diaphragm 111 reduces the volume of the chamber 105, thus causing fluid to be ejected through the orifice 113. As the fluid exits the chamber 105 through the orifice 113, the flow separates at the (preferably sharp) edges of the orifice 113 and creates vortex sheets 121. These vortex sheets 121 roll into vortices 123 and begin to move away from the edges of the orifice 109 in the direction indicated by arrow 119.

FIG. 1c depicts the synthetic jet ejector 101 as the diaphragm 111 is controlled to move outward with respect to the chamber 105, as depicted by arrow 127. The outward motion of the diaphragm 111 causes the volume of chamber 105 to increase, thus drawing ambient fluid 115 into the chamber 105 as depicted by the set of arrows 129. The diaphragm 111 is controlled by the control system 117 so that, when the diaphragm 111 moves away from the chamber 105, the vortices 123 are already removed from the edges of the orifice 113 and thus are not affected by the ambient fluid 115 being drawn into the chamber 105. Meanwhile, a jet of ambient fluid 115 is synthesized by the vortices 123, thus creating strong entrainment of ambient fluid drawn from large distances away from the orifice 109.

Despite the many advantages of synthetic jet ejectors, further improvements in these devices are still necessary. By way of example, some current and future applications for synthetic jet ejectors, such as the incorporation of synthetic jet ejectors into mobile phones, mobile technology platforms and other such devices, will require these devices to have very small profiles. There is thus a need in the art for synthetic jet ejectors which have small form factors and which are suitable for use in such applications. However, there is also a need in the art for methods to make such synthetic jet ejectors in a cost effective manner, an objective which is complicated by the need for miniaturization.

It has now been found that the foregoing needs may be met with the devices and methodologies disclosed herein. In particular, it has been found that synthetic jet ejectors with very small profiles may be achieved through the use of synthetic jet ejectors based on moving armature technology. It has further been found that such synthetic jet ejectors may be made in a cost effective manner by utilizing a multilayer design in which the individual layers are planar (or relatively planar) and register effectively with the chassis or other components to simplify assembly.

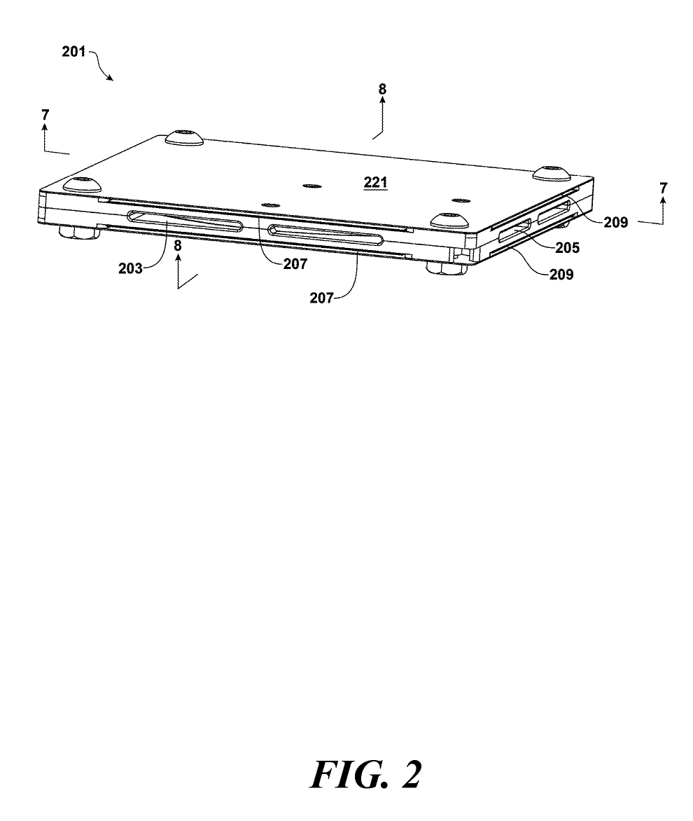

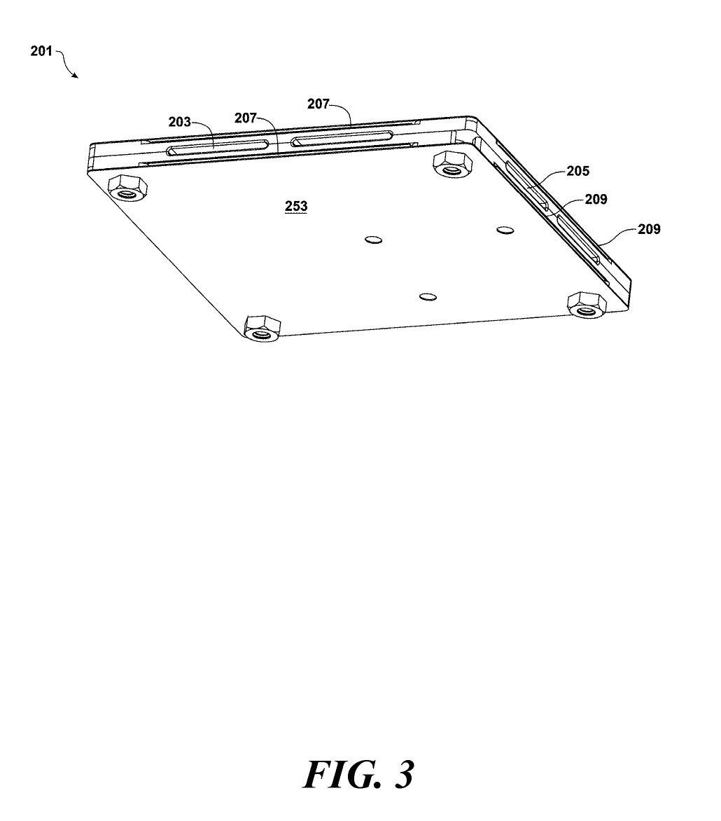

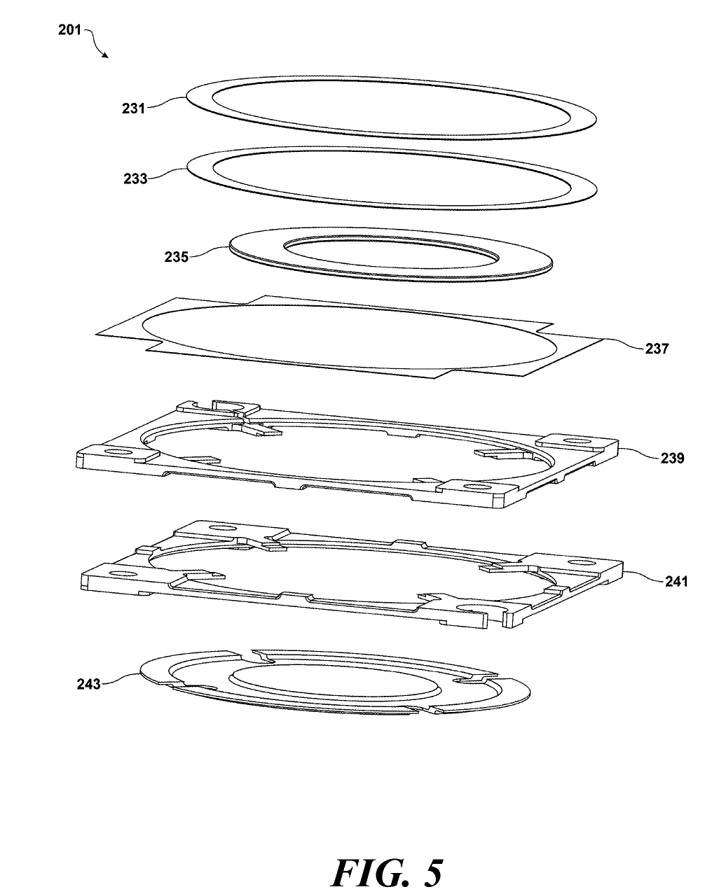

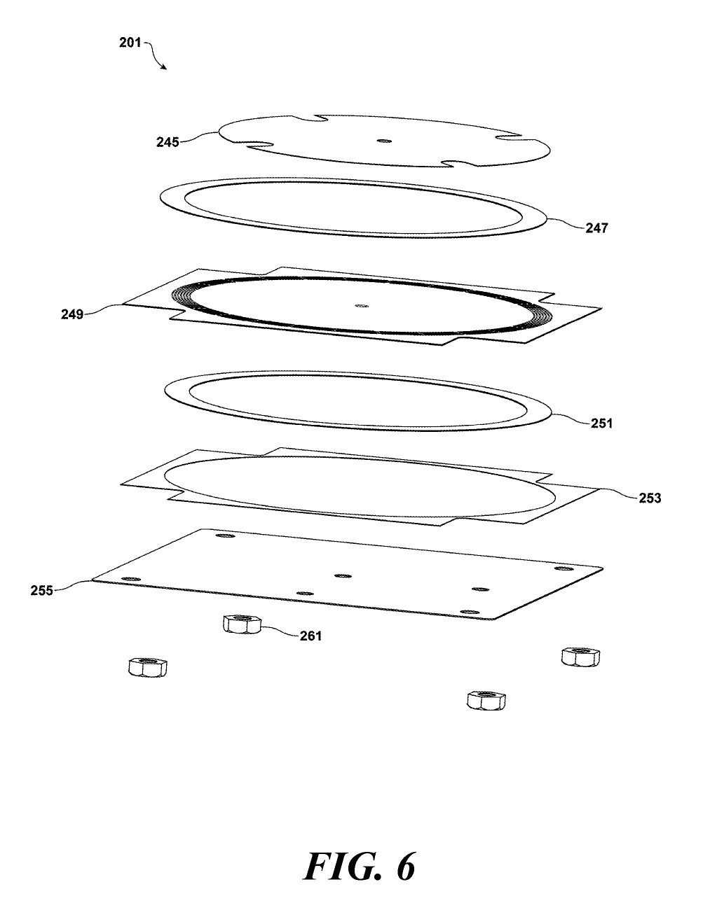

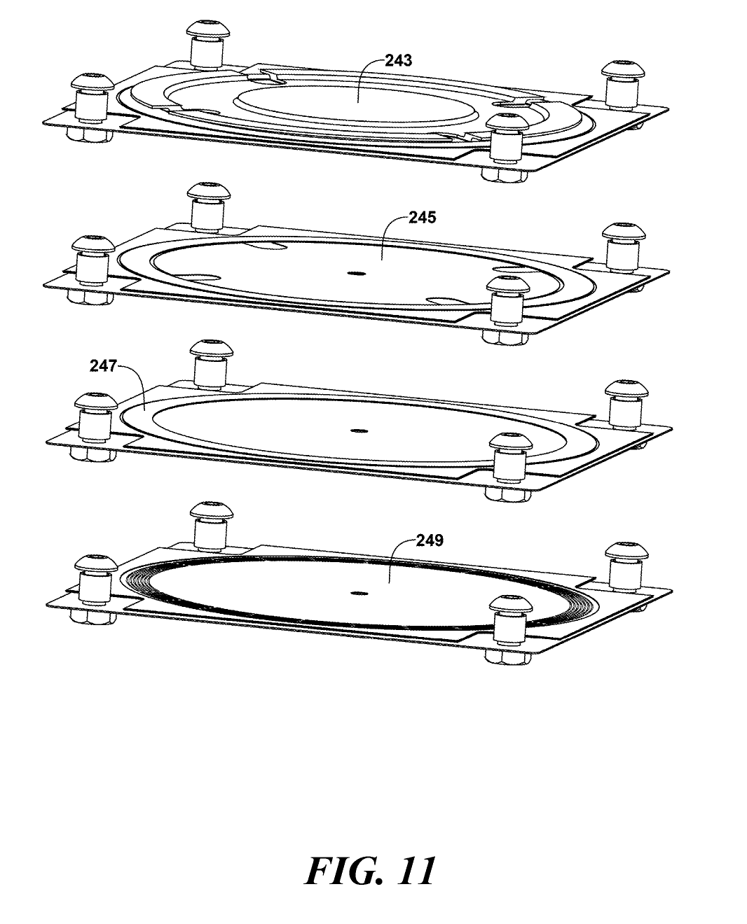

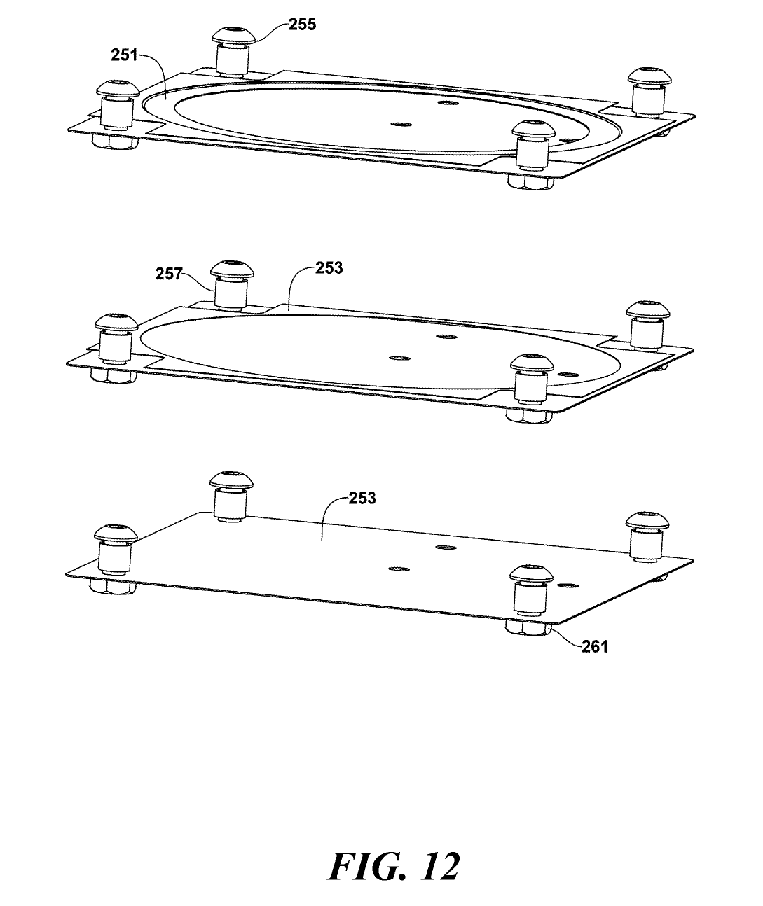

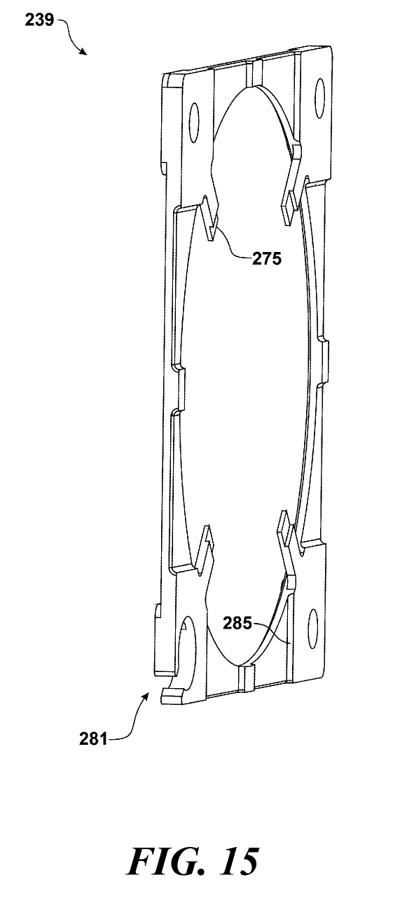

FIGS. 2-16 illustrate a particular, non-limiting embodiment of a synthetic jet ejector made in accordance with the teachings herein. As seen in FIGS. 2-3, in the particular embodiment depicted, the synthetic jet ejector 201 is a thin, generally planar device which is equipped with first 203 and second 205 sets of primary apertures and first 207 and second 209 sets of secondary apertures. The synthetic jet ejector operates to emit synthetic jets from these apertures 203, 205, 207 and 209. However, it will be appreciated that variations of this embodiment are possible in which a greater or smaller number of apertures are utilized, and those apertures may be present on any surface of the device. Moreover, the synthetic jet ejector may have a wide variety of shapes or dimensions, although the low profile of the embodiment depicted is advantageous in many applications where space in the host device is limited.

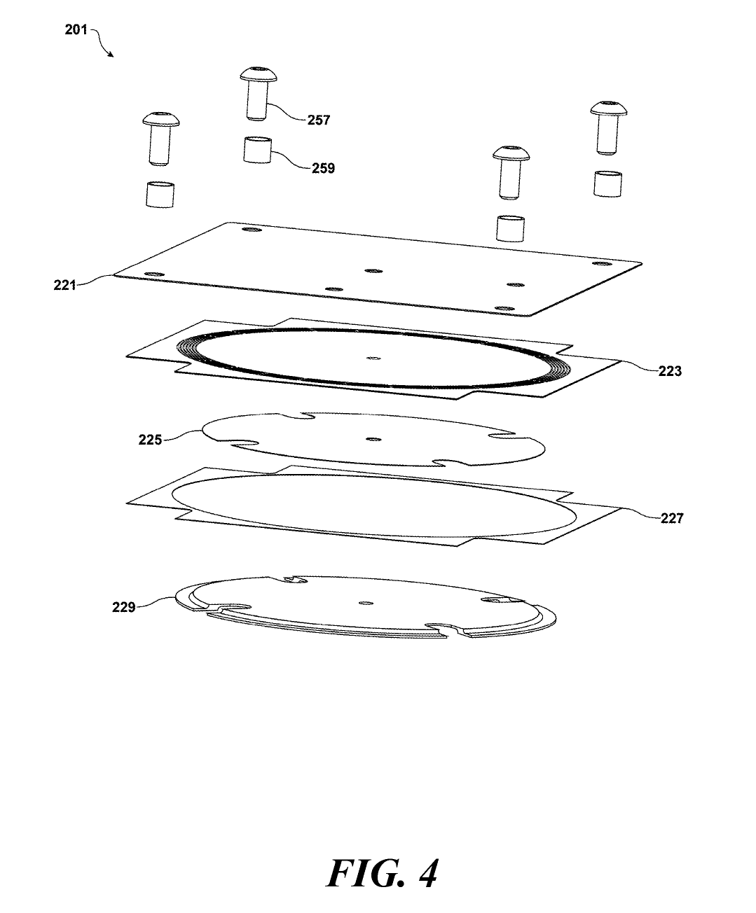

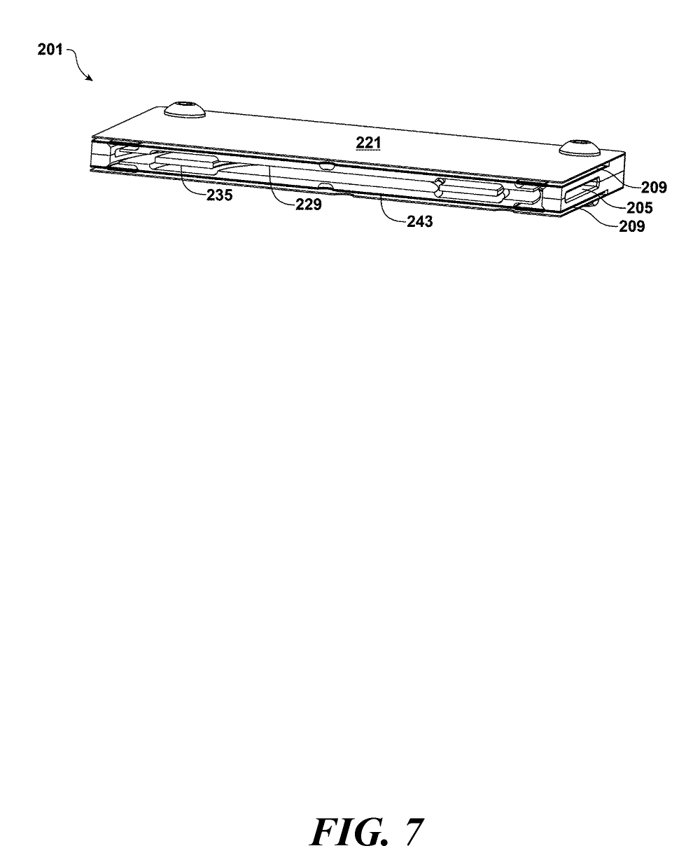

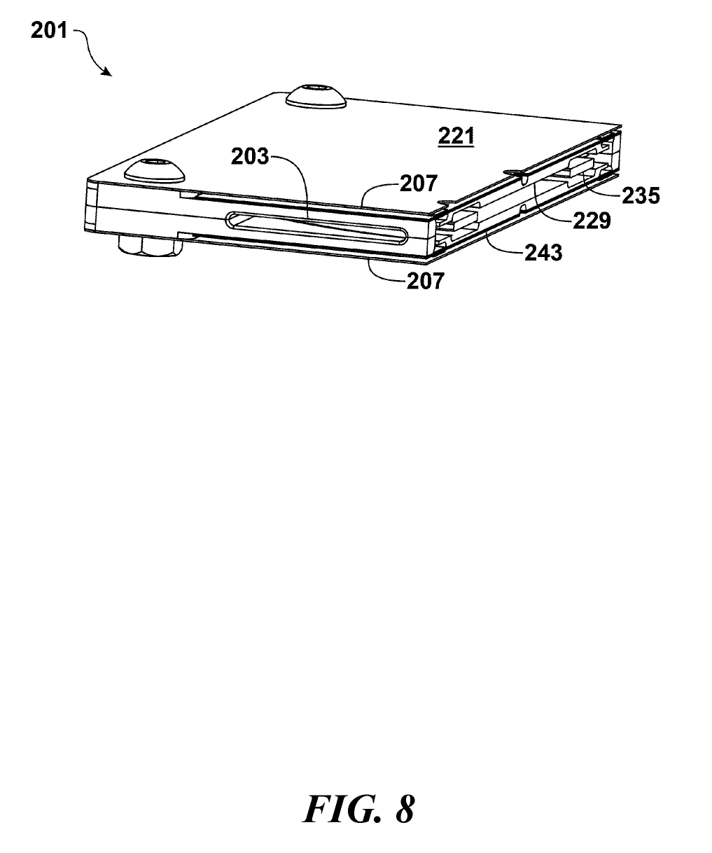

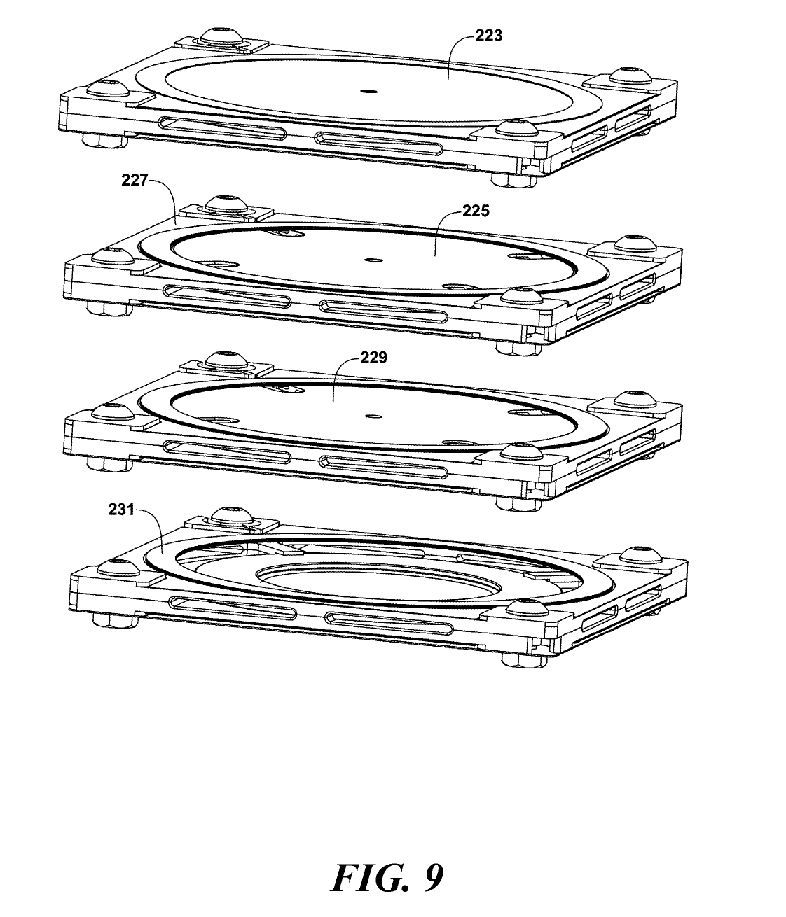

The interior construction of the synthetic jet ejector 201 may be further appreciated with respect to FIGS. 4-6 (which collectively show an exploded view of the synthetic jet ejector of FIG. 2), with respect to FIGS. 7-8 (which show, respectively, cross-sectional views of the synthetic jet ejector of FIG. 2 taken along LINES 7-7 and 8-8, respectively), and FIGS. 9-12 (which show the synthetic jet ejector of FIG. 2 in successive states of disassembly). As seen therein, the synthetic jet ejector 201 comprises (from top to bottom) a top plate 221, a first diaphragm 223, first 225 and second 227 adhesive layers, a first armature 229, first 231 and second 233 over moldings, a coil 235, a third adhesive layer 237, a first chassis element 239, a second chassis element 241, a second armature 243, a fourth adhesive layer 245, a third over molding 247, a second diaphragm 249, a fourth over molding 251, a fifth adhesive layer 253, and a bottom plate 255. The foregoing elements are held together by a set of threaded bolts 257, a set of sleeves 259 through which the threaded bolts 257 extend, and a set of threaded nuts 261 that the threaded bolts 257 rotatingly engage with.

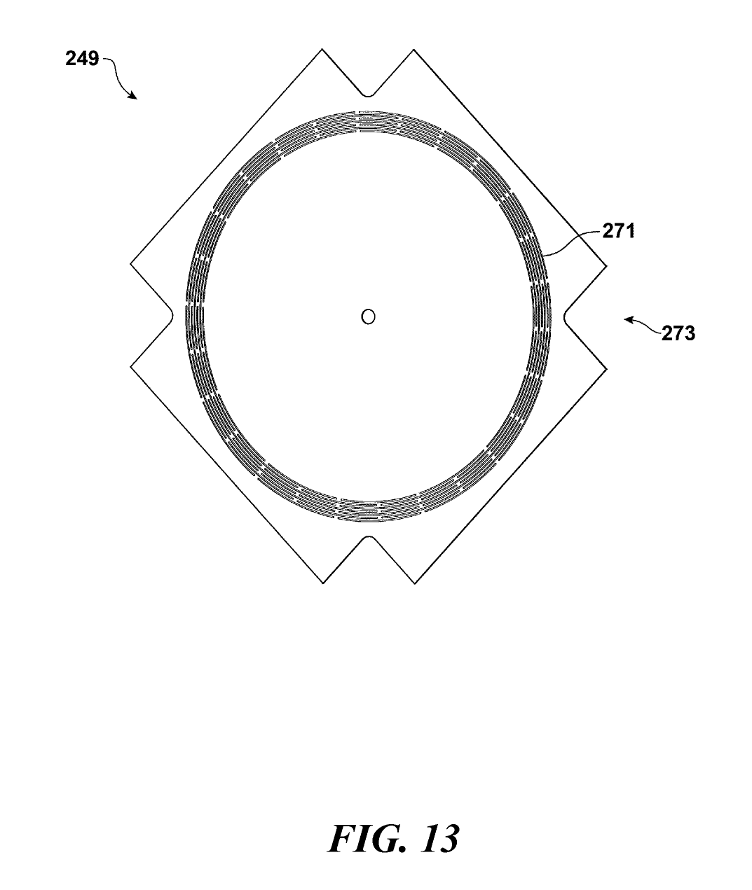

FIG. 13 illustrate in greater detail a diaphragm used in the synthetic jet ejector of FIG. 2. As seen therein, the diaphragm 249 is equipped with a plurality of cut-outs 271. These cut-outs 271 improve the flexibility of the diaphragm 249, thus allowing larger displacements of the diaphragm 249 with the application of smaller actuator forces. This, in turn, may reduce noise levels and vibrations in some applications. The cut-outs may be of various geometries, and the choice of geometry may depend on the end use or the properties required of the diaphragm. Moreover, the diaphragm may be made of various materials including, for example, metals, plastics or polymers. A (preferably thin) coating or layer is applied to one or both surfaces of the diaphragm 249 to seal the cut-outs 271, thus providing the desired improvement in flexibility without adversely affecting the ability of the diaphragm 249 to drive a fluid.

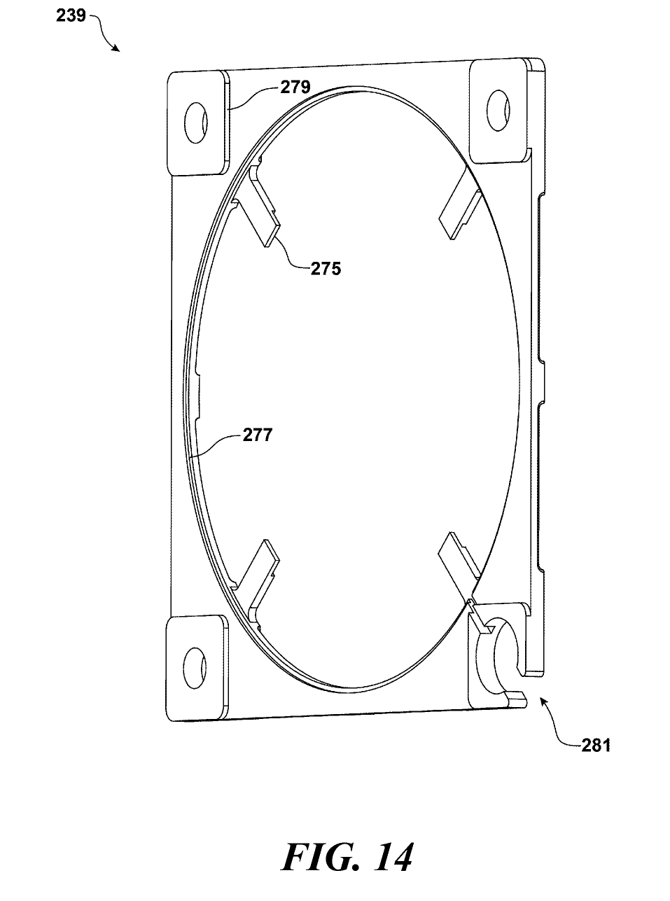

The diaphragm 249 is also provided with one or more features that allow it to be keyed to the first 239 and second 241 chassis elements or other components during assembly. In the embodiment depicted, these features take the form of a plurality of notches 273 in the diaphragm, which engage a set of complimentary shaped protrusions 279 (see FIG. 14) in the first 239 and second 241 chassis elements, thus greatly simplifying assembly. Hence, as seen in FIGS. 4-6, during assembly, the diaphragms 223, 249 and any intervening components may simply be placed on the first 239 and second 241 chassis elements, and these features will properly key them to their respective chassis element while assembly is being completed.

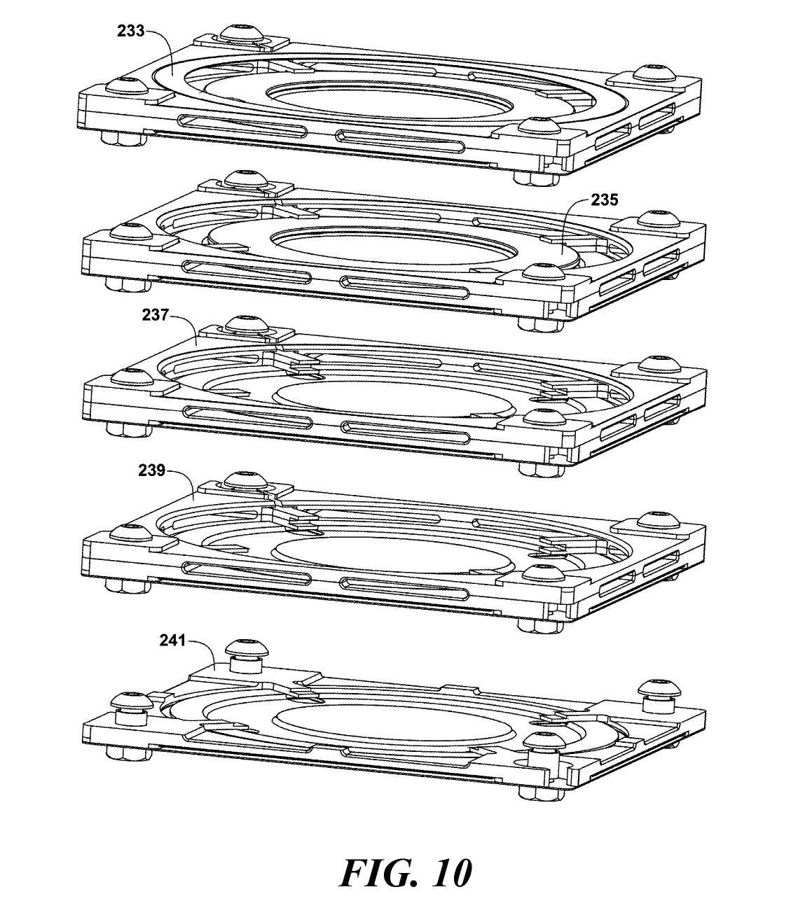

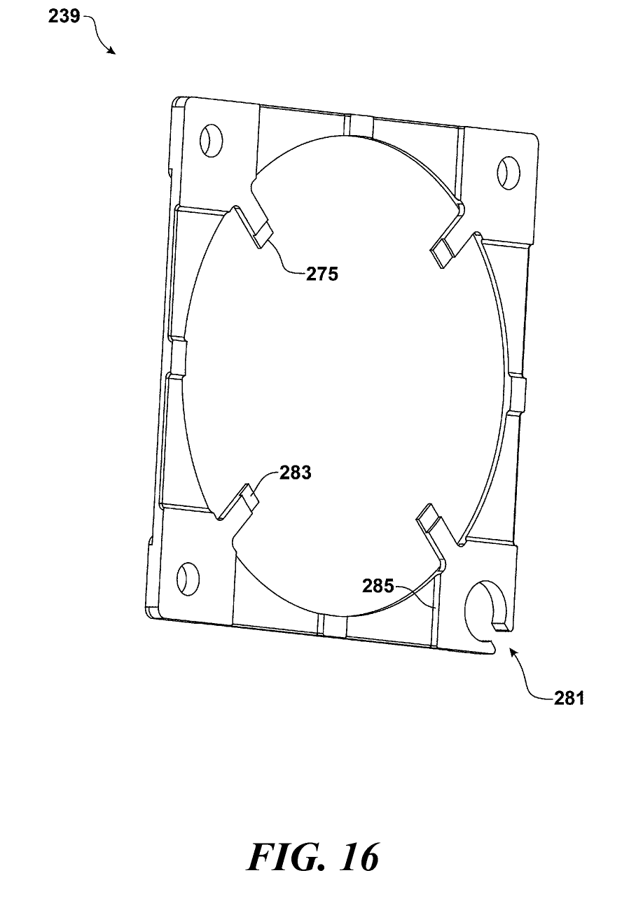

The first 239 and second 241 chassis elements are similarly provided with support elements to properly support and key the coil 235 in place. In the embodiment depicted, these support elements take the form of a plurality of fingers 275 (see FIGS. 14-16) which are disposed about the periphery of a circular opening 277 provided in the first 239 and second 241 chassis elements. Each finger 275 is equipped with a beveled section (see FIG. 16) whose shape and dimensions are such that, when the first 239 and second 241 chassis elements are fastened together, the coil 235 is held firmly between them (see, e.g., FIG. 10).

Each of the first 239 and second 241 chassis elements is also equipped with a notch 281 which is complimentary in shape to, and releasably engages, an electrical adapter (not shown) for the coil 235. This electrical adapter may, for example, include the circuitry needed to control the operation of the coil 235 (e.g., the circuitry needed to produce the requisite oscillations in the first 223 and second 249 diaphragms).

In operation, an oscillating current or voltage is applied to the coil 235, which causes the first 223 and second 229 armatures, and hence the first 223 and second 249 diaphragms to which they are attached, to be alternately attracted and repelled. At appropriate frequencies, this periodic motion creates a flow of fluid into and out of apertures 203, 205, 207 and 209 which is sufficient to entrain the ambient fluid and induce the formation of synthetic jets therein.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

The current listing of claims is as follows:

1. A synthetic jet ejector, comprising:
a housing assembly which is equipped with a first plurality of openings and a second plurality of openings; and
a diaphragm assembly disposed within said housing assembly, wherein said diaphragm assembly includes (a) first and second armatures, (b) a coil disposed between said first and second armatures, (c) first and second end caps, (d) a first diaphragm disposed between said first end cap and said first armature, and (e) a second diaphragm disposed between said second end cap and said second armature;
wherein said first and second diaphragms contain a first set of keying features which keys them to the housing assembly, wherein said synthetic jet ejector emits a first plurality of synthetic jets out of said first plurality of openings, and wherein said synthetic jet ejector emits a second plurality of synthetic jets out of said second plurality of openings.

2. The synthetic jet ejector of claim 1, wherein each of said first and second diaphragms contains a plurality of cut-outs.

3. The synthetic jet ejector of claim 1, wherein said housing assembly includes a second set of keying features which releasably mate with said first set of keying features.
